(19) United States
(12) Patent Application Publication
(10) Pub. No.: US 2026/0160598 A1
(43) Pub. Date: Jun. 11, 2026

(54) ENDOSCOPIC PLASMA MONOCHROMATIC LIGHT ANALYSIS SYSTEM

(71) Applicant: Hefei Institutes of Physical Sciences, Chinese Academy of Sciences, Hefei (CN)

(72) Inventors: Fang DING, Hefei (CN); HaiShan ZHOU, Hefei (CN); ZhenHua HU, Hefei (CN); ZhongShi YANG, Hefei (CN); GuangNan LUO, Hefei (CN)

(21) Appl. No.: 19/401,183

(22) Filed: Nov. 25, 2025

(30) Foreign Application Priority Data
Dec. 9, 2024 (CN) 202411800222.1

(51) Int. Cl. G01J 3/28; G01J 3/02; G21B 1/25

(52) U.S. Cl. CPC G01J 3/2803; G01J 3/0208; G01J 3/0218; G21B 1/25

(57) ABSTRACT

The present disclosure discloses an endoscopic plasma monochromatic light analysis system, belonging to the magnetically confined plasma field. The system consists of multiple sets of optical lens groups, a flexible optical fiber array, narrowband filters, dichroic mirrors, beam splitter mirrors, optical detectors, an indicating light source, and position adjustment motors. By rotating, the front-end reflecting mirror transmits plasma emission lights from different positions to a collecting lens such that the lights focus onto an optical fiber array end face. The flexible optical fiber array is used to extract plasma emission light from inside complex structures to a low-radiation area. The light extracted by the optical fiber array is converted into a parallel light by a telecentric lens set, then passes through a narrowband filter of a specific wavelength, and then is imaged onto an optical detector via a converging lens, thereby obtaining spatial distribution and temporal evolution information of plasma monochromatic light at a specific wavelength. According to the technical solution of the present disclosure, the demand for remote collection and analysis of two-dimensional spectral characteristics of plasmas can be satisfied.

### BACKGROUND

### Technical Field

The present disclosure can be applied to spectral analysis of magnetically confined plasma, and particularly relates to an endoscopic plasma monochromatic light analysis system. The system can pass through the complex magnets, cryogenic structures, radiation shielding, and other mechanical structures surrounding the plasma device, and by real-time monitoring and adjustment of the collimated light path, achieve relatively accurate acquisition and analysis of the two-dimensional characteristics of plasma spectra.

### Description of the Related Art

Magnetically confined plasma devices, such as Tokamak devices, have complex magnetic field coils arranged around their periphery. To obtain steady-state strong magnetic fields, these coils need to operate in the superconducting state and thus need to be placed in an extremely low temperature environment. High-performance magnetically confined plasmas require radiation shielding to ensure personnel and equipment safety. Therefore, various complex mechanical structures are mounted at the periphery of the magnetically confined plasma, making it difficult to directly mount large-scale integrated optical systems. The spatial distribution of magnetically confined plasma varies significantly and changes rapidly over time. To characterize and analyze the numerous underlying information, it is necessary to simultaneously acquire the two-dimensional distribution and evolution information of different monochromatic lights and perform corresponding computational processing. In addition, to obtain monochromatic light with a specific central wavelength through a filter, the incident light needs to have good collimation, otherwise, the difference in incident angle will cause the central wavelength passing through the filter to shift. Therefore, it is necessary to develop an endoscopic plasma monochromatic light analysis system with a compact and flexible structure that can bypass complex mechanical structures and monitor and adjust the beam collimation in real time so as to provide an experimental basis for the performance evaluation and operation control of magnetically confined plasmas.

### BRIEF SUMMARY

The present disclosure provides an endoscopic plasma monochromatic light analysis system. Through a first reflecting mirror at front-end and a collecting lens, plasma lights from different positions are focused onto the entrance position of an optical fiber array. The light passes through the complex peripheral structure of the magnetically confined plasma via a flexible optical fiber array, then undergoes optical collimation and waveband selection of a narrowband filter, and then is focused onto an optical detector. This allows simultaneous acquisition of two-dimensional distribution and temporal evolution information of multiple monochromatic lights from the plasma, which, after computation, enables various kinds of key plasma information.

According to one aspect of the present disclosure, an endoscopic plasma monochromatic light analysis system is provided, comprising: a first position adjustment motor, a second position adjustment motor, a third position adjustment motor, a fourth position adjustment motor, a first reflecting mirror, a collecting lens, an optical fiber array, an indicating optical fiber, an indicating light source, a telecentric collimating lens, a first beam splitter, a second beam splitter, a first narrowband filter, a first converging lens, a first optical detector, a second reflecting mirror, a third reflecting mirror, and a semi-transparent screen, with positional relationships among the components as follows:
after the indicating light source is turned on, indicating light is transmitted through the indicating optical fiber to a right exit position of the optical fiber array, and becomes a parallel light beam after passing through the telecentric collimating lens. Partial light beams at two positions in a path of the parallel light beam are extracted by the first beam splitter and the second beam splitter; and the partial light beams, after being reflected respectively by the second reflecting mirror and the third reflecting mirror, are projected onto both sides of a semi-transparent screen, wherein a cone angle of the light beam can be calculated by comparing light spot sizes on both sides of the semi-transparent screen. The cone angle of the light beam can be adjusted to zero by changing the right exit position of the optical fiber array driven by the third position adjustment motor, thus obtaining a parallel light beam.

The parallel light beam passes through the first narrowband filter and then becomes a monochromatic light. The monochromatic light is imaged onto a photosensitive chip of the first optical detector by the first converging lens, and the position of the first optical detector is adjusted via the fourth position adjustment motor to achieve optimal imaging clarity.

After optical collimation and focus adjustment, the indicating light source is turned off. The first position adjustment motor is used to orient the first reflecting mirror toward a target plasma. The plasma light collected by the first reflecting mirror is imaged at a left entrance position of the optical fiber array via the collecting lens, transmitted through the optical fiber array to its right exit position, and then converted into a parallel light beam by the collimating lens; the parallel light beam passes through the first narrowband filter and then becomes a monochromatic light beam, and the monochromatic light beam is then imaged onto the first optical detector by the first converging lens, so as to obtain two-dimensional image information of the monochromatic light, wherein adjusting the left entrance position of the optical fiber array via the second position adjustment motor enables further adjustment of imaging clarity.

According to another aspect of the present disclosure, an endoscopic plasma monochromatic light analysis system is provided, comprising the following components: a first position adjustment motor, a second position adjustment motor, a third position adjustment motor, a fourth position adjustment motor, a first reflecting mirror, a collecting lens, an optical fiber array, an indicating optical fiber, an indicating light source, a telecentric collimating lens, a first beam splitter, a second beam splitter, a first narrowband filter, a first converging lens, a first optical detector, a second narrowband filter, a third narrowband filter, a second converging lens, a third converging lens, a second optical detector, a third optical detector, a fifth position adjustment motor, and a sixth position adjustment motor. The positional relationships among the components are as follows:
after the indicating light source is turned on, the indicating light is transmitted through the indicating optical fiber to a right exit position of an optical fiber array, then becomes a parallel light beam after passing through the collimating lens; the first beam splitter and the second beam splitter extract partial light beams at two positions in a path of the parallel light beam, the partial light beams respectively pass through the second narrowband filter and the third narrowband filter, as well as the second converging lens and the third converging lens, and are finally imaged on photosensitive chips of the second optical detector and the third optical detector; the fifth position adjustment motor is used to adjust a position of the second optical detector, and the sixth position adjustment motor is used to adjust a position of the third optical detector, until optimal imaging clarity is achieved; and by comparing a difference in light spot sizes obtained by the second optical detector and the third optical detector, a cone angle of the light beam can be calculated, based on which the third position adjustment motor adjusts a position of the right exit position of the optical fiber array to obtain a parallel light beam;
the parallel light beam passes through the first narrowband filter and then becomes a monochromatic light, the monochromatic light is imaged onto a photosensitive chip of the first optical detector by the first converging lens, and the position of the first optical detector is adjusted via the fourth position adjustment motor to achieve optimal imaging clarity; and after optical collimation and focus adjustment, the indicating light source is turned off, and the first position adjustment motor is used to orient the first reflecting mirror toward a target plasma; a plasma light collected by the first reflecting mirror is imaged at a left entrance position of the optical fiber array via the collecting lens, transmitted through the optical fiber array to its right exit position, and then converted into a parallel light beam by the telecentric collimating lens; and the parallel light beam passes through the first narrowband filter and then becomes a monochromatic light beam, and the monochromatic light beam is then imaged onto the first optical detector by the first converging lens, so as to obtain two-dimensional image information of the monochromatic light, wherein adjusting the left entrance position of the optical fiber array via the second position adjustment motor enables further adjustment of imaging clarity.

The beneficial effects of the present disclosure are as follows.

The plasma light from magnetically confined plasmas surrounded by complex structures can be guided out along a detour path. By utilizing a combination of a dichroic mirror, a beam splitter mirror, a collimation light path, and narrowband filters, together with configured optical collimation and focus monitoring and adjustment structures, the collimation of the parallel light can be monitored and adjusted in real time, enabling relatively accurate acquisition of spatiotemporal information of monochromatic light at multiple kinds of central wavelengths. After computational processing, it can be used for monitoring and analyzing the state of magnetically confined plasmas, thereby promoting performance evaluation of magnetically confined plasmas and providing data support for the optimization of the operational control.

The present disclosure can adapt to the limited space and tortuous pathways caused by the complex structure of fusion plasma devices, while simultaneously enabling real-time monitoring and adjustment of the collimation of the light path, thereby satisfying the requirements for remote acquisition and analysis of two-dimensional spectral characteristics of plasmas.

### BRIEF DESCRIPTION OF THE SEVERAL VIEWS OF THE DRAWINGS

FIG. 1 is a schematic diagram of a first type of structure of an endoscopic plasma monochromatic light analysis system according to the present disclosure.

FIG. 2 is a schematic diagram of a second type of structure of an endoscopic plasma monochromatic light analysis system according to the present disclosure.

FIG. 3 is a working flowchart of an endoscopic plasma monochromatic light analysis system according to the present disclosure.

### DESCRIPTION OF REFERENCE NUMERALS

first position adjustment motor 1, second position adjustment motor 2, third position adjustment motor 3, fourth position adjustment motor 4, first reflecting mirror 5, collecting lens 6, optical fiber array 7, indicating optical fiber 8, indicating light source 9, telecentric collimating lens 10, first beam splitter 11, second beam splitter 12, first narrowband filter 13, first converging lens 14, first optical detector 15, second reflecting mirror 16, third reflecting mirror 17, semi-transparent screen 18, second narrowband filter 19, third narrowband filter 23, second converging lens 20, third converging lens 24, second optical detector 21, third optical detector 25, fifth position adjustment motor 22, and sixth position adjustment motor 26.

### DETAILED DESCRIPTION

Exemplary implementation modes of the present disclosure will be described in more detail below with reference to the accompanying drawings. Although the accompanying drawings illustrate exemplary implementation modes of the present disclosure, it should be understood that the present disclosure can be implemented in various forms and should not be limited by the implementation modes set forth herein. On the contrary, these implementation modes are provided so that this disclosure can be understood thoroughly and the scope of this disclosure can be fully conveyed to those skilled in the art.

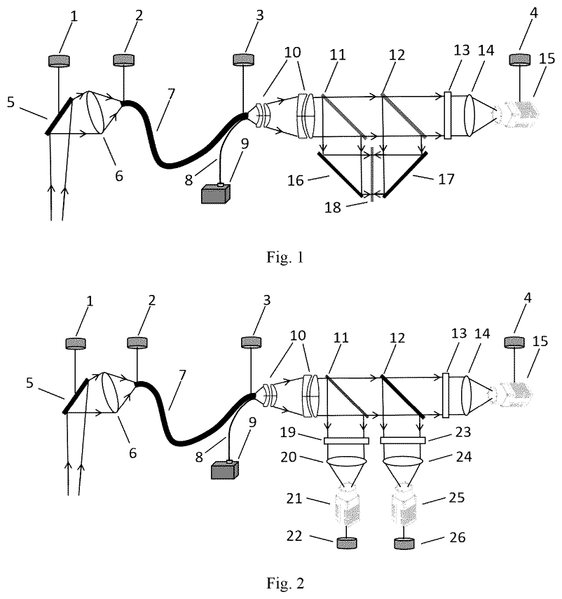

FIG. 1 is a schematic diagram of a first type of structure of the endoscopic plasma monochromatic light analysis system according to the present disclosure. As shown in FIG. 1, the system includes the following components: a first position adjustment motor 1, a second position adjustment motor 2, a third position adjustment motor 3, a fourth position adjustment motor 4, a first reflecting mirror 5, a collecting lens 6, an optical fiber array 7, an indicating optical fiber 8, an indicating light source 9, a telecentric collimating lens 10, a first beam splitter 11, a second beam splitter 12, a first narrowband filter 13, a first converging lens 14, a first optical detector 15, a second reflecting mirror 16, a third reflecting mirror 17, and a semi-transparent screen 18. The positional relationships among the components are as follows.

After the indicating light source 9 is turned on, the indication light is transmitted through the indicating optical fiber 8 to the right exit position of the optical fiber array 7, and becomes a parallel light beam after passing through the telecentric collimating lens 10. The first beam splitter 11 and the second beam splitter 12 extract partial light beams from two positions in the path of the parallel light beam, and then the partial light beams are projected onto both sides of the semi-transparent screen 18 after being reflected by the second reflecting mirror 16 and the third reflecting mirror 17, respectively. By comparing the light spot sizes on both sides of the semi-transparent screen 18, the cone angle of the light beam can be determined. The third position adjustment motor 3 adjusts the right exit position (which coincides with the port position of the indicating optical fiber 8) of the optical fiber array 7 to alter the cone angle of the light beam until the cone angle becomes zero, thereby achieving a parallel light beam.

The parallel light beam passes through the first narrowband filter 13 to become monochromatic light (the spectral bandwidth depends on the transmission bandwidth of the narrowband filter), and is imaged onto the photosensitive chip of the first optical detector 15 via the first converging lens 14. The position of the first optical detector 15 is adjusted using the fourth position adjustment motor 4 to achieve optimal imaging clarity.

After completing the optical collimation and focus adjustments, the indicating light source 9 is turned off. The first position adjustment motor 1 rotates the first reflecting mirror 5 toward a target plasma. The plasma light collected by the first reflecting mirror 5 is imaged at the left entrance position of the optical fiber array 7 after passing through the collecting lens 6, transmitted through the optical fiber array 7 to its right exit position, and then converted into a parallel light beam by the telecentric collimating lens 10. The parallel light beam becomes a monochromatic light beam after passing through the first narrowband filter 13, and is imaged onto the first optical detector 15 via the first converging lens 14 so as to obtain two-dimensional image information of the monochromatic light. The imaging clarity can be further adjusted by the second position adjustment motor 2, adjusting the left entrance position of the optical fiber array 7.

By replacing the first narrowband filter 13 with different central wavelengths, two-dimensional image information of multiple kinds of monochromatic lights in the plasma can be obtained.

During system operation, the plasma monochromatic light analysis system can monitor the cone angle of the light beam in real time by observing the difference in light spot sizes on both sides of the semi-transparent screen, and make adjustments as needed to obtain parallel light, thereby ensuring the accuracy of the collected monochromatic light wavelength.

In one implementation mode, the indicating light source may be monochromatic light, such as a laser light, or a broad-spectrum light source.

In summary, the first reflecting mirror at front-end rotates to transmit plasma emission light from different positions to the collecting lens, and then the same is focused onto the end face of optical fiber array. The flexible optical fiber array is used to guide the plasma emission light through complex device structures to a low-radiation area outside the device. Plasma emission light led out by the optical fiber array is converted into parallel light beam by a collimation lens, passes through a narrowband filter of a specific wavelength, and then is imaged onto an optical detector via a converging lens, thereby obtaining spatial distribution and temporal evolution information of plasma monochromatic light at specific wavelengths. Inserting a dichroic mirror or a beam splitter mirror after the collimation lens enables the collection of spatiotemporal information of multiple kinds of monochromatic lights, thereby satisfying various analytical requirements. The system is configured with a beam collimation monitoring and adjustment unit to improve the accuracy of the monochromatic light wavelength passing through the narrowband filter, and achieves clear imaging by adjusting the positions of the fiber end head and the optical detector.

In one implementation mode, the first position adjustment motor, the second position adjustment motor, and the third position adjustment motor can be directly driven by motors or indirectly driven via motor-controlled pneumatic cylinders, with the motors placed in a low-magnetic-field region to reduce the influence of strong magnetic fields on motor operation.

In one implementation mode, the collecting lens and the telecentric collimating lens both adopt a telecentric lens light path design composed of two lens groups, enabling good optical coupling with the two-dimensional optical fiber array light source.

A dichroic mirror or beam splitter mirror is inserted after the telecentric collimating lens so as to separate plasma light by wavelength or energy; and the light then passes through narrowband filters with different central wavelengths and is focused onto optical detectors via a converging lens, achieving simultaneous collection of spatiotemporal information of multiple kinds of monochromatic lights.

The system is configured with an optical collimation monitoring and focus adjustment mechanism. By introducing an indicating light source at the exit end face of the optical fiber array, and providing beam splitter mirrors at two positions along the parallel light path to extract parallel light for light spot size comparison detection, the optical fiber array exit position is adjusted based on the detection results to optimize the collimation of the parallel light. The rear-end monochromatic light acquisition channel can use an optical detector to obtain the light spot size and intensity information of the monochromatic indicating light, thereby adjusting the positions of the optical fiber end head and the optical detector via a position adjustment motor to achieve imaging clarity adjustment on the optical detector.

In one implementation mode, the first optical detector 15 may be a two-dimensional imaging detector or a point detector array. The two-dimensional imaging detector is directly coupled with the first converging lens, while the point detector array is coupled with the first converging lens through an optical fiber array.

Plasma emission light exiting from optical fiber array 7 becomes parallel light after passing through the telecentric collimating lens, and is transmitted through a narrowband filter of a specific wavelength at a near-zero degree incidence angle, thereby becoming monochromatic light. Incidence at a near-zero degree avoids the central wavelength shift caused by large-angle incidence through the filter.

The monochromatic light passing through the narrowband filter is imaged onto a two-dimensional optical detector via a converging lens, thereby obtaining spatial distribution and temporal evolution information of plasma monochromatic light at a specific wavelength. Alternatively, it may be imaged onto a two-dimensional optical fiber array end face via the converging lens, and then guided to multiple single-point optical detectors through separated optical fibers at the other end.

Inserting a dichroic mirror between the collimating lens and the converging lens can separate plasma light according to wavelength bands, directing them into narrowband filters with different central wavelengths, so that corresponding monochromatic light images are obtained by optical detectors. A beam splitter mirror can also be inserted after the collimating lens to split an incident beam into two beams at a certain energy ratio, directing them respectively through narrowband filters with different central wavelengths, and obtaining corresponding monochromatic light images via optical detectors, thereby forming multiple monochromatic light acquisition channels. Dichroic mirrors and beam splitter mirrors can be selected according to different beam splitting requirements, and can also be used simultaneously at different positions in the light path.

The system is configured with an optical collimation and focus monitoring adjustment mechanism. By introducing an indicating light source at the optical fiber array exit end face, and providing beam splitter mirrors at two positions along the parallel light path to extract parallel light for light spot size comparison detection, the optical fiber array exit position is adjusted based on the detection results to optimize the collimation of the parallel light. In the back-end monochromatic light acquisition channel, the light spot size and intensity information of the monochromatic indicating light can be acquired by using the optical detector, and the position of the optical fiber end head and the optical detector can be adjusted via the position adjustment motor to optimize the light spot size and intensity distribution, achieving clarity adjustment.

The system may further include a computer for obtaining the two-dimensional distribution of plasma characteristic spectral line intensities at different wavelengths and their ratios, thereby obtaining plasma state distribution information, such as electron-ion recombination process images, electron temperature relative distribution images, and the like.

FIG. 2 is a schematic diagram of a second type of structure of an endoscopic plasma monochromatic light analysis system according to the present disclosure. As shown in FIG. 2, the system includes the following components: a first position adjustment motor 1, a second position adjustment motor 2, a third position adjustment motor 3, a fourth position adjustment motor 4, a first reflecting mirror 5, a collecting lens 6, an optical fiber array 7, an indicating optical fiber 8, an indicating light source 9, a telecentric collimating lens 10, a first beam splitter 11, a second beam splitter 12, a first narrowband filter 13, a first converging lens 14, a first optical detector 15, a second narrowband filter 19, a third narrowband filter 23, a second converging lens 20, a third converging lens 24, a second optical detector 21, a third optical detector 25, a fifth position adjustment motor 22, and a sixth position adjustment motor 26. The positional relationships among the components are as follows.

After the indicating light source 9 is turned on, the indication light is transmitted through the indicating optical fiber 8 to the right exit position of the optical fiber array 7, and becomes a parallel light beam after passing through the telecentric collimating lens 10. The first beam splitter 11 and the second beam splitter 12 extract partial light beams at two positions of the parallel light beam path, and the partial light beams then pass through the second narrowband filter 19 and the third narrowband filter 23 (the second narrowband filter and the third narrowband filter being identical) and the second converging lens 20 and the third converging lens 24, respectively, and finally form images on the photosensitive chips of the second optical detector 21 and the third optical detector 25. The fifth position adjustment motor 22 is used to adjust the position of the second optical detector 21, and the sixth position adjustment motor 26 is used to adjust the position of the third optical detector 25 until optimal imaging clarity is achieved. By comparing the difference in light spot sizes obtained by the second optical detector 21 and the third optical detector 25, the cone angle of the light beam can be calculated. Based on this, the position of the right exit of the optical fiber array 7 is adjusted via the third position adjustment motor 3 to obtain a parallel light beam. This configuration enables more precise collimation adjustment for the measured monochromatic light.

The parallel light beam passes through the first narrowband filter 13 to become monochromatic light (the spectral bandwidth depends on the transmission bandwidth of the narrowband filter), and is imaged onto the photosensitive chip of the first optical detector 15 via the first converging lens 14. The position of the first optical detector 15 is adjusted using the fourth position adjustment motor 4 to achieve optimal imaging clarity.

After completing the optical collimation and focus adjustments, the indicating light source 9 is turned off. The first position adjustment motor 1 rotates the first reflecting mirror 5 toward a target plasma. The plasma light collected by the first reflecting mirror 5 is imaged at the left entrance position of the optical fiber array 7 after passing through the collecting lens 6, transmitted through the optical fiber array 7 to its right exit position, and then converted into a parallel light beam by the telecentric collimating lens 10. The parallel light beam becomes a monochromatic light beam after passing through the first narrowband filter 13, and is imaged onto the first optical detector 15 via the first converging lens 14 so as to obtain two-dimensional image information of the monochromatic light. The imaging clarity can be further adjusted by the second position adjustment motor 2, adjusting the left entrance position of the optical fiber array 7.

In one implementation mode, narrowband filters with different central wavelengths may be placed at the positions of the first narrowband filter 13, the second narrowband filter 19, and the third narrowband filter 23, enabling simultaneous acquisition of two-dimensional distribution information of multiple monochromatic lights. At this point, at the positions of the first beam splitter 11 and the second beam splitter 12, either a beam splitter mirror can be mounted to split the beam into two light beams by energy, or a dichroic mirror can be mounted to split the beam into two light beams by wavelength, thereby improving the energy utilization efficiency of the monochromatic light. Images acquired using different monochromatic light channels can be used to calculate the two-dimensional distribution of plasma characteristic spectral line intensities at various wavelengths and their ratios, thereby obtaining plasma state distribution information, such as electron-ion recombination process images, electron temperature relative distribution images, and the like.

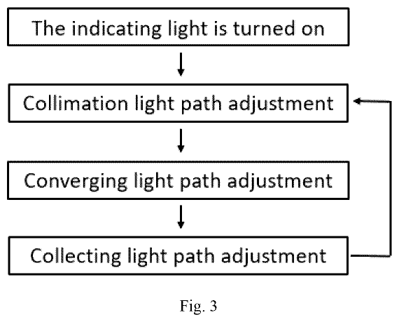

FIG. 3 is a basic operation flow chart of the endoscopic plasma monochromatic light analysis system according to the present disclosure. First, the indicating light source 9 is turned on, and the indicating light is transmitted via the indicating optical fiber 8 to the right exit position of the optical fiber array 7. Then, performing light beam collimation detection and adjustment using the collimation light path is conducted. The collimation light path in FIG. 1 consists of a third position adjustment motor 3, a telecentric collimating lens 10, a first beam splitter 11, a second beam splitter 12, a second reflecting mirror 16, a third reflecting mirror 17, and a semi-transparent screen 18. The collimation light path in FIG. 2 consists of a third position adjustment motor 3, a telecentric collimating lens 10, a first beam splitter 11, and a second beam splitter 12. After collimation adjustment, the parallel light beam enters the converging light path and is finally imaged and acquired on the optical detector. FIG. 1 includes one set of converging light path, composed of a first narrowband filter 13, a first converging lens 14, a first optical detector 15, and a fourth position adjustment motor 4. FIG. 2 includes three sets of converging light paths, two more than those in FIG. 1. The three sets of converging light paths consist of a second narrowband filter 19, a third narrowband filter 23, a second converging lens 20, a third converging lens 24, a second optical detector 21, a third optical detector 25, a fifth position adjustment motor 22, and a sixth position adjustment motor 26. The same narrowband filters are mounted in the two sets of converging light paths of FIG. 2 for accurately detecting light beam collimation, or different narrowband filters may be mounted to simultaneously obtain multiple kinds of monochromatic light information of the plasma. In FIG. 2, the collecting light path consists of a first reflecting mirror 5, a first position adjustment motor 1, a second position adjustment motor 2, a collecting lens 6, and an optical fiber array 7. After completing the pre-adjustment of the collimation light path and converging light path using the indicating light, the indicating light is turned off, starting to collect plasma light signals is performed, and the collection light path is adjusted according to the image from the optical detector. During the operation of the monochromatic light analysis system, the collimation light path can be monitored in real time, and both the collimation light path and the converging light path can be further optimized and adjusted to ensure the accuracy of the collected monochromatic light image.

The various embodiments described above can be combined to provide further embodiments. Aspects of the embodiments can be modified, if necessary to employ concepts of the various embodiments to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An endoscopic plasma monochromatic light analysis system, characterized by comprising components below: a first position adjustment motor, a second position adjustment motor, a third position adjustment motor, a fourth position adjustment motor, a first reflecting mirror, a collecting lens, an optical fiber array, an indicating optical fiber, an indicating light source, a telecentric collimating lens, a first beam splitter, a second beam splitter, a first narrowband filter, a first converging lens, a first optical detector, a second reflecting mirror, a third reflecting mirror, and a semi-transparent screen, with positional relationships among the components as follows:
after the indicating light source is turned on, an indicating light is transmitted through the indicating optical fiber to a right exit position of the optical fiber array, and becomes a parallel light beam after passing through the telecentric collimating lens, and partial light beams at two positions in a path of the parallel light beam are extracted by the first beam splitter and the second beam splitter; and the partial light beams, after being reflected respectively by the second reflecting mirror and the third reflecting mirror, are projected onto both sides of the semi-transparent screen, wherein a cone angle of the light beam can be judged by comparing light spot sizes on both sides of the semi-transparent screen, and the cone angle of the light beam is adjusted by the third position adjustment motor adjusting the right exit position of the optical fiber array, until the cone angle reaches zero, thus obtaining a parallel light beam;
the parallel light beam passes through the first narrowband filter and then becomes a monochromatic light, the monochromatic light is imaged onto a photosensitive chip of the first optical detector by the first converging lens, and a position of the first optical detector is adjusted via the fourth position adjustment motor to achieve optimal imaging clarity; and after optical collimation and focus adjustment, the indicating light source is turned off. The first position adjustment motor is used to orient the first reflecting mirror toward a target plasma; a plasma light collected by the first reflecting mirror is imaged at a left entrance position of the optical fiber array via the collecting lens, transmitted through the optical fiber array to its right exit position, and then converted into a parallel light beam by the telecentric collimating lens; the parallel light beam passes through the first narrowband filter and then becomes a monochromatic light beam, and the monochromatic light beam is then imaged onto the first optical detector by the first converging lens, so as to obtain two-dimensional image information of the monochromatic light, wherein adjusting the left entrance position of the optical fiber array via the second position adjustment motor enables further adjustment of imaging clarity.

2. The endoscopic plasma monochromatic light analysis system according to claim 1, characterized in that:
the indicating light source comprises one of the following: a laser light, and a broadband light source;
driving modes of the first position adjustment motor, the second position adjustment motor, and the third position adjustment motor comprise one of the following: direct motor drive, and motor-controlled cylinder indirect drive; and
both the collecting lens and the telecentric collimating lens employ a telecentric lens light path design, each consisting of two lens groups.

3. The endoscopic plasma monochromatic light analysis system according to claim 1, characterized in that:
the first optical detector is a two-dimensional imaging detector or a point detector array, wherein, when the first optical detector is a two-dimensional imaging detector, the two-dimensional imaging detector is directly coupled with the first converging lens; and when the first optical detector is a point detector array, the point detector array is coupled with the first converging lens via a fiber array.

4. The endoscopic plasma monochromatic light analysis system according to claim 1, characterized in that:
at positions of the first beam splitter and the second beam splitter, a beam splitter mirror is mounted to split the light beam into two light beams by energy, or a dichroic mirror is mounted to split the light beam into two light beams by wavelength.

5. The endoscopic plasma monochromatic light analysis system according to claim 1, characterized by further comprising a computer configured to obtain a two-dimensional distribution of characteristic spectral line intensities at different wavelengths of the plasma and their ratios from an image captured by the first optical detector.

6. An endoscopic plasma monochromatic light analysis system, characterized by comprising components below: a first position adjustment motor, a second position adjustment motor, a third position adjustment motor, a fourth position adjustment motor, a first reflecting mirror, a collecting lens, an optical fiber array, an indicating optical fiber, an indicating light source, a telecentric collimating lens, a first beam splitter, a second beam splitter, a first narrowband filter, a first converging lens, a first optical detector, a second narrowband filter, a third narrowband filter, a second converging lens, a third converging lens, a second optical detector, a third optical detector, a fifth position adjustment motor, and a sixth position adjustment motor, with positional relationships among the components as follows:
after the indicating light source is turned on, the indicating light is transmitted through the indicating optical fiber to a right exit position of an optical fiber array, then becomes a parallel light beam after passing through the telecentric collimating lens; the first beam splitter and the second beam splitter extract partial light beams at two positions in a path of the parallel light beam, the partial light beams respectively pass through the second narrowband filter and the third narrowband filter, as well as the second converging lens and the third converging lens, and are finally imaged on photosensitive chips of the second optical detector and the third optical detector; the fifth position adjustment motor is used to adjust a position of the second optical detector, and the sixth position adjustment motor is used to adjust a position of the third optical detector, until optimal imaging clarity is achieved; and by comparing a difference in light spot sizes obtained by the second optical detector and the third optical detector, a cone angle of the light beam can be calculated, based on which the third position adjustment motor adjusts a position of the right exit position of the optical fiber array to obtain a parallel light beam;
the parallel light beam passes through the first narrowband filter and then becomes a monochromatic light, the monochromatic light is imaged onto a photosensitive chip of the first optical detector by the first converging lens, and a position of the first optical detector is adjusted via the fourth position adjustment motor to achieve optimal imaging clarity; and
after optical collimation and focus adjustment, the indicating light source is turned off, and the first position adjustment motor is used to orient the first reflecting mirror toward a target plasma; a plasma light collected by the first reflecting mirror is imaged at a left entrance position of the optical fiber array via the collecting lens, transmitted through the optical fiber array to its right exit position, and then converted into a parallel light beam by the telecentric collimating lens; the parallel light beam passes through the first narrowband filter and then becomes a monochromatic light beam, and the monochromatic light beam is then imaged onto the first optical detector by the first converging lens, so as to obtain two-dimensional image information of the monochromatic light, wherein adjusting the left entrance position of the optical fiber array via the second position adjustment motor enables further adjustment of imaging clarity.

7. The endoscopic plasma monochromatic light analysis system according to claim 6, characterized in that narrowband filters of different wavelengths are placed at positions of the first narrowband filter, the second narrowband filter, and the third narrowband filter; and at positions of the first beam splitter and the second beam splitter, a beam splitter mirror is mounted to split the light beam into two light beams by energy, or a dichroic mirror is mounted to split the light beam into two light beams by wavelength.
